(19) United States
(12) Patent Application Publication
(10) Pub. No.: US 2012/0154716 A1
(43) Pub. Date: Jun. 21, 2012

(54) LIQUID CRYSTAL DISPLAY

(75) Inventors: Yasuyoshi Kaise, Osaka-shi (JP); Hiroyuki Ohgami, Osaka-shi (JP)

(73) Assignee: SHARP KABUSHIKI KAISHA, Osaka-shi (JP)

(21) Appl. No.: 13/392,781

(22) PCT Filed: Aug. 27, 2010
(86) PCT No.: PCT/JP2010/064630

§ 371 Date: Feb. 27, 2012

(30) Foreign Application Priority Data
Aug. 28, 2009 (JP) 2009-198976

(51) Int. Cl. G02F 1/1343; G02F 1/1333

(52) U.S. Cl. 349/85; 349/144

(57) ABSTRACT

A liquid crystal display device (100) according to the present invention includes: a plurality of pixel electrodes (124) arranged in a matrix array of a plurality of rows and a plurality of columns; a counter electrode (144); and a liquid crystal layer (160) interposed between the plurality of pixel electrodes (124) and the counter electrode (144). The counter electrode (144) includes a plurality of split counter electrodes (145), and each of the plurality of split counter electrodes (145) overlaps a portion of a pixel electrode (124) in each of two adjoining rows. Alternatively, each of the plurality of split counter electrodes (145) may overlap an entire pixel electrode (124) in each corresponding row.

### REFERENCE TO RELATED APPLICATIONS

This application is the national stage under 35 USC 371 of International Application No. PCT/JP2010/064630, filed Aug. 27, 2010, which claims priority from Japanese Patent Application No. 2009-198976, filed Aug. 28, 2009, the entire contents of which are incorporated herein by reference.

### FIELD OF THE INVENTION

The present invention relates to a liquid crystal display device.

### BACKGROUND OF THE INVENTION

Liquid crystal display devices are used not only as large-sized television sets, but also as small-sized display devices, e.g., the display sections of mobile phones. Liquid crystal display devices of the TN (Twisted Nematic) mode, which have often been used conventionally, have relatively narrow viewing angles. In recent years, however, liquid crystal display devices with wide viewing angles have been produced, e.g., the IPS (In-Plane Switching) mode and the VA (Vertical Alignment) mode. Among such wide-viewing angle modes, the VA mode is adopted in a large number of liquid crystal display devices because of an ability to realize a high contrast ratio.

As one kind of VA mode, the MVA (Multi-domain Vertical Alignment) mode is known, under which a plurality of liquid crystal domains are created in one pixel region. An

MVA-mode liquid crystal display device includes alignment regulating structures provided on the liquid-crystal-layer side of at least one of a pair of opposing substrates, between which a vertical-alignment type liquid crystal layer is interposed. The alignment regulating structures may be linear slits (apertures) or ribs (protruding structures) that are provided on electrodes, for example. The alignment regulating structures provide alignment regulating forces from one side or both sides of the liquid crystal layer, thus creating a plurality of liquid crystal domains (typically four liquid crystal domains) with different alignment directions, whereby the viewing angle characteristics are improved.

Also known as another kind of VA mode is the CPA (Continuous Pinwheel Alignment) mode. In a generic liquid crystal display device of the CPA mode, pixel electrodes of a highly symmetrical shape are provided, and on the liquid crystal layer side of a counter substrate, apertures and protrusions are provided corresponding to the centers of liquid crystal domains. These protrusions are also referred to as rivets. When a voltage is applied, in accordance with an oblique electric field which is created with the counter electrode and a highly symmetrical pixel electrode, liquid crystal molecules take an inclined alignment of a radial shape. Moreover, in the case where rivets are provided, the inclined alignment of the liquid crystal molecules are stabilized due to the alignment regulating forces of side slopes of the rivets. Thus, the liquid crystal molecules in one pixel are aligned in a radial shape, thereby improving the viewing angle characteristics.

As a disadvantage of VA modes, an outstanding difference is known to exist between the display quality as observed in the frontal direction and the display quality as observed in oblique directions. Especially in gray scale displaying, if an adjustment is made so that appropriate displaying characteristics are obtained when observed in the frontal direction, the displaying characteristics when observed in oblique directions, e.g., coloration and gamma characteristics, will significantly differ from the displaying characteristics in the frontal direction. The optic axis direction of a liquid crystal molecule is the major axis direction of the molecule, and the optic axis direction of the liquid crystal molecule will be somewhat inclined from the principal faces of the substrates during gray scale displaying. The displaying characteristics when the viewing angle (the direction of observation) is varied from this state so as to result in an observation in an oblique direction which is parallel to the optic axis direction of the liquid crystal molecule will be significantly different from the displaying characteristics in the frontal direction.

Specifically, a displayed image which is observed in an oblique direction will appear entirely whitish relative to the displayed image as observed in the frontal direction. This phenomenon is also referred to as “whitening”. For example, in the case of displaying a human face, even if the facial expressions and the like of the person are perceived naturally in the frontal direction, they may appear entirely whitish when observed in an oblique direction, such that subtle gray scale expressions of the flesh color appear whitened out.

In order to improve on such whitening, one pixel electrode is divided into plural (typically two) subpixel electrodes such that the subpixel electrodes have different potentials, whereby plural (typically two) subpixels are formed. In such a liquid crystal display device, the gray scale characteristics of the subpixels are adjusted so that the display quality in any oblique direction is not deteriorated from the display quality in the frontal direction (see, for example, Patent Documents 1 to 3).

In the liquid crystal display device which is disclosed in Patent Document 1, two subpixel electrodes are connected to different source lines via different switching elements, and are driven so that the two subpixel electrodes have different potentials. Since the potentials of the subpixel electrodes are thus different, there will be different applied voltages across the liquid crystal layers of the subpixels, so that the subpixels will have respectively different transmittances. As a result of this, whitening is alleviated.

In the liquid crystal display device disclosed in Patent Document 2, different switching elements corresponding to two subpixel electrodes are connected to different gate lines. The liquid crystal display device of Patent Document 2 is driven so that the two gate lines, at least partially, become ON at different points in time, thus ensuring that the two subpixel electrodes have different potentials.

In the liquid crystal display device disclosed in Patent Document 3, together with two subpixel electrodes, storage capacitor lines are provided each of which, directly or indirectly, forms a storage capacitor with the corresponding subpixel electrode. Since different CS voltages are applied to the storage capacitor lines, the effective applied voltage across the liquid crystal layer is varied. In the liquid crystal display device of Patent Document 3, whitening is alleviated in this manner.

### PATENT LITERATURE

[Patent Document 1] Japanese Laid-Open Patent Publication No. 2006-209135

[Patent Document 2] Japanese Laid-Open Patent Publication No. 2006-139288

[Patent Document 3] Japanese Laid-Open Patent Publication No. 2004-62146

### SUMMARY OF THE INVENTION

In the liquid crystal display device of Patent Document 1, two source lines must be provided for each column of pixels, thus increasing the number of source lines. In the liquid crystal display device of Patent Document 2, two gate lines must be provided for each row of pixels, thus increasing the number of gate lines. Furthermore, in the liquid crystal display devices of Patent Documents 1 and 2, a TFT must be provided for each subpixel electrode. Therefore, the aperture ratio of the display region will be decreased in the liquid crystal display devices of Patent Documents 1 and 2.

In the liquid crystal display device of Patent Document 3, the applied voltages across the liquid crystal layers of the subpixels will not differ so much as the difference in CS voltages. Especially, in the case where the TFTs have a large gate-drain capacitance, the difference between the effective applied voltages across the liquid crystal layers of the subpixels will not be so large in spite of the differing CS voltages, and thus the difference in transmittance between the subpixels will not be sufficiently large. In this case, if the gray scale characteristics of the subpixels were to be adjusted adequately, the power consumption would have to increase. Thus, whitening cannot be efficiently alleviated.

The present invention has been made in view'of the above problems, and an objective thereof is to provide a liquid crystal display device which suppresses a decrease in the aperture ratio of a display region and which efficiently alleviates whitening.

A liquid crystal display device according to the present invention is a liquid crystal display device comprising: a plurality of pixel electrodes arranged in a matrix array of a plurality of rows and a plurality of columns; a counter electrode; and a liquid crystal layer interposed between the plurality of pixel electrodes and the counter electrode, wherein, the counter electrode includes a plurality of split counter electrodes; and each of the plurality of split counter electrodes overlaps a portion of a pixel electrode in each of two adjoining rows.

A liquid crystal display device according to the present invention is a liquid crystal display device comprising: a plurality of pixel electrodes arranged in a matrix array of a plurality of rows and a plurality of columns; a counter electrode; and a liquid crystal layer interposed between the plurality of pixel electrodes and the counter electrode, wherein, the counter electrode includes a plurality of split counter electrodes; and each of the plurality of split counter electrodes overlaps an entire pixel electrode in each corresponding row.

In one embodiment, when a gray scale level of an input image signal corresponding to a given pixel remains unchanged over a plurality of vertical scanning periods of the liquid crystal display device, a region corresponding to one of two adjoining split counter electrodes corresponding to the given pixel has a luminance higher than a luminance of a region corresponding to the other split counter electrode in a given vertical scanning period, but the region corresponding to the one split counter electrode has a luminance lower than a luminance of the region corresponding to the other split counter electrode in another vertical scanning period.

In one embodiment, when a gray scale level of an input image signal corresponding to a given pixel remains unchanged over a plurality of vertical scanning periods of the liquid crystal display device, an average of luminances of regions corresponding to two split counter electrodes that correspond to the given pixel over a plurality of consecutive vertical scanning periods corresponds to the gray scale level of the input image signal.

In one embodiment, when a gray scale level of an input image signal corresponding to a given pixel remains unchanged over a plurality of vertical scanning periods of the liquid crystal display device, an average between a luminance of the region corresponding to the one split counter electrode and a luminance of the region corresponding to the other split counter electrode corresponds to the gray scale level of the input image signal in any arbitrary vertical scanning period.

In one embodiment, when a gray scale level of an input image signal corresponding to a given pixel remains unchanged over a plurality of vertical scanning periods of the liquid crystal display device, a luminance of a region corresponding to a split counter electrode corresponding to the given pixel in a given vertical scanning period is different from a luminance of the region corresponding to the split counter electrode corresponding to the given pixel in another vertical scanning period.

In one embodiment, when a gray scale level of an input image signal corresponding to a given pixel remains unchanged over a plurality of vertical scanning periods of the liquid crystal display device, an average of the luminance of the region corresponding to the split counter electrode corresponding to the given pixel taken over a plurality of consecutive vertical scanning periods corresponds to the gray scale level of the input image signal.

In one embodiment, when gray scale levels of input image signals corresponding to all pixels remain unchanged over a plurality of vertical scanning periods of the liquid crystal display device, a region corresponding to one of two adjoining split counter electrodes has a luminance higher than a luminance of a region corresponding to the other split counter electrode in a given vertical scanning period, but the region corresponding to the one split counter electrode has a luminance lower than a luminance of the region corresponding to the other split counter electrode in another vertical scanning period.

In one embodiment, each of the plurality of split counter electrodes has a shape extending along a row direction.

In one embodiment, under an applied voltage, liquid crystal molecules in the liquid crystal layer are aligned in first, second, third, and fourth reference alignment azimuths differing from one another by an integer multiple of essentially 90 degrees.

In one embodiment, a width of each of the plurality of split counter electrodes is essentially equal to a length of each of the plurality of pixel electrodes along a column direction.

A liquid crystal display device according to the present invention can suppress a decrease in the aperture ratio of the display region, and efficiently alleviate whitening.

### BRIEF DESCRIPTION OF THE DRAWINGS

FIG. 1 A schematic diagram of a first embodiment of a liquid crystal display device according to the present invention.

FIG. 2 A schematic plan view of the liquid crystal display device shown in FIG. 1.

FIG. 3 A schematic diagram showing wiring lines on a counter substrate of the liquid crystal display device shown in FIG. 1.

FIG. 4 A graph showing changes in V-T characteristics in accordance with potentials of the counter electrode.

FIG. 5 A waveform diagram showing counter electrode signals to be supplied to first and second split counter electrodes.

FIG. 6 A schematic diagram showing a liquid crystal display device of Comparative Example.

FIG. 7 A schematic plan view showing a second embodiment of a liquid crystal display device according to the present invention.

### DETAILED DESCRIPTION OF THE INVENTION

Hereinafter, with reference to the drawings, embodiments of the liquid crystal display device according to the present invention will be described. However, the present invention is not limited to the following embodiments.

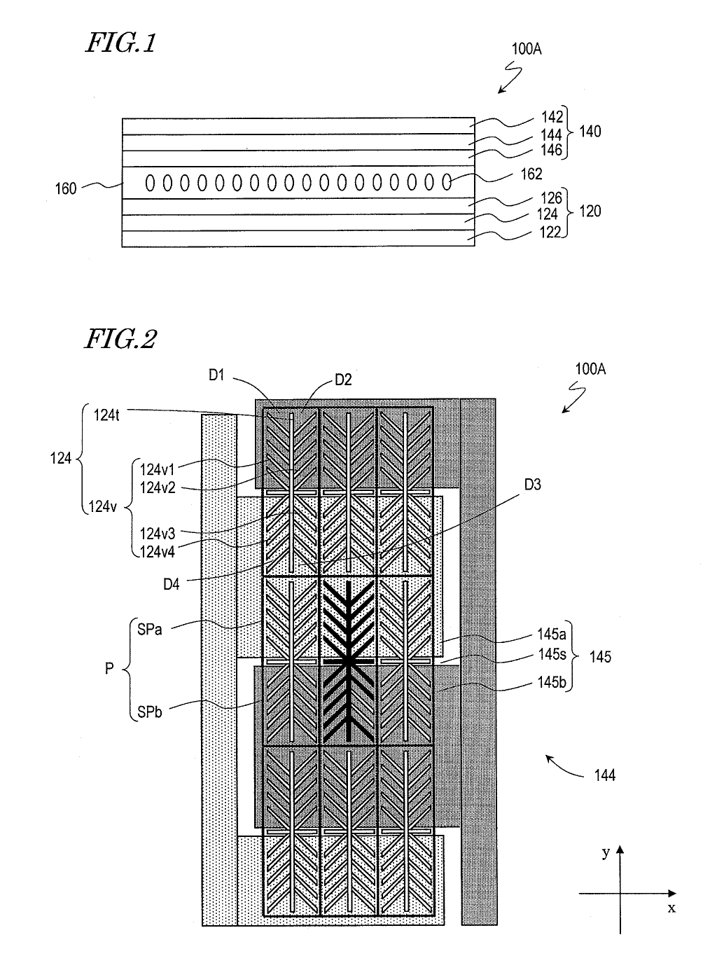

Hereinafter, a first embodiment of the liquid crystal display device according to the present invention will be described. FIG. 1 shows a schematic diagram of a liquid crystal display device 100A according to the present embodiment, and FIG. 2 shows a schematic plan view of the liquid crystal display device 100A.

The liquid crystal display device 100A includes: an active matrix substrate 120 having pixel electrodes 124 and an alignment film 126 provided on an insulative substrate 122; a counter substrate 140 having a counter electrode 144 and an alignment film 146 provided on an insulative substrate 142; and a liquid crystal layer 160 provided between the active matrix substrate 120 and the counter substrate 140. On the active matrix substrate 120 and the counter substrate 140, polarizers which are not shown are provided, such that the polarization axes of the polarizers are in crossed Nicols. The liquid crystal layer 160 has an essentially constant thickness. Note that the liquid crystal display device 100A may include a backlight as necessary.

In the liquid crystal display device 100A, a plurality of pixels are arranged in a matrix array of a plurality of rows and a plurality of columns. In the case of a liquid crystal display device which performs color displaying by using the primary colors of R (red), G (green), and B (blue), for example, one color is expressed by three pixels of R, G, and B. Pixels are defined by the pixel electrodes 124.

The liquid crystal display device 100A operates in a VA mode. The alignment films 126 and 146 are vertical alignment films. The liquid crystal layer 160 is a vertical-alignment type liquid crystal layer. As used herein, a “vertical-alignment type liquid crystal layer” means a liquid crystal layer in which the liquid crystal molecular axes (also referred to as the “axial azimuths”) are aligned at angles of about 85° or more relative to the surfaces of the vertical alignment films 126 and 146. The liquid crystal molecules have a negative dielectric anisotropy, and in cooperation with the polarizers placed in crossed Nicols, perform displaying in a normally black mode. When no voltage is applied across the liquid crystal layer 160, liquid crystal molecules 162 in the liquid crystal layer 160 are aligned essentially in parallel to the normal directions of the principal faces of the alignment films 126 and 146. When a voltage which is higher than a predetermined voltage is applied across the liquid crystal layer 160, the liquid crystal molecules 162 in the liquid crystal layer 160 are aligned essentially in parallel to the principal faces of the alignment films 126 and 146. Although it is illustrated herein that the active matrix substrate 120 and the counter substrate 140 respectively have the alignment films 126 and 146, at least one of the active matrix substrate 120 and the counter substrate 140 may have a corresponding alignment film 126 or 146. However, from the standpoint of alignment stability, it is preferable that both of the active matrix substrate 120 and the counter substrate 140 have their respective alignment films 126 and 146.

FIG. 2 schematically shows pixels in the liquid crystal display device 100A. FIG. 2 illustrates 3 rows by 3 columns of pixels. Although not shown herein, gate lines extend along the x direction and source lines extend along the y direction, and TFTs are provided near intersections of the gate lines and the source lines. As necessary, storage capacitor lines may be provided which extend in parallel to the gate lines.

Each pixel electrode 124 has a cross-shaped stem 124t and branches 124v extending from the stem 124t. The branches 124v which are formed in four regions defined by the cross-shaped stem 124t are designated branches 124v1 to 124v4. Defining the horizontal direction (right-left direction) on the display screen (plane of the figure) as a reference of the azimuthal direction, and defining the leftwise rotation as positive (i.e., if the display surface were a clock face, the 3 o'clock direction would be an azimuth angle of 0°, and the counterclockwise would be positive), the branches 124v1 and 124v3 extend in an azimuth angle direction of 135° and an azimuth angle direction of 315°, whereas the branches 124v2 and 124v4 extend in an azimuth angle direction of 45° and an azimuth angle direction of 225°. Such a structure of the pixel electrode 124 is also called a fishbone structure. When a voltage is applied across the liquid crystal layer 160, the liquid crystal molecules 162 are aligned so that their azimuths are parallel to the branches 124v1 to 124v4, whereby liquid crystal domains D1 to D4 are created. Each pixel electrode 124 is sized 135 μm×45 μm. The width of the stem 124t, the width of the branches 124v, and the pitch of the branches 124v are 4 μm, 2.5 μm, and 5.0 μm, respectively.

In the liquid crystal display device 100A of the present embodiment, the counter electrode 144 includes a plurality of electrodes 145 which are separate from one another. In the present specification, such separated electrodes are referred to as “split counter electrodes”. In the liquid crystal display device 100A, the split counter electrodes 145 extend linearly along the row direction. In the following description, such linearly-extending split counter electrodes may also be referred to as linear counter electrodes. A linear slit 145s is provided between adjoining linear counter electrodes 145. The split counter electrodes 145 have a width (length along the y direction) of 135 μm, and the slits 145s have a width of 5 μm.

In the liquid crystal display device 100A, a split counter electrode 145 overlaps portions of pixel electrodes 124 in each of two adjoining rows, such that any pixel electrode 124 in each row corresponds to two split counter electrodes 145. Specifically, the branches 124v1 and 124v2 of the pixel electrode 124 overlap one split counter electrode 145, whereas the branches 124v3 and 124v4 of the pixel electrode 124 overlap another split counter electrode 145. Each slit 145s is provided so as to correspond to the interval between the branches 124v1 and 124v2 and the branches 124v3 and 124v4 of pixel electrodes 124. The number of split counter electrodes 145 is substantially equal to the number of rows of pixel electrodes 124, and the split counter electrodes 145 have a width which is substantially equal to that along the column direction (length along the y direction) of the pixel electrodes 124.

Now, those split counter electrodes 145 which overlap the branches 124v1 and 124v2 of any given pixel electrode 124 are designated split counter electrodes 145a, and those which overlap the branches 124v3 and 124v4 of that pixel electrode 124 are designated split counter electrodes 145b. In the present specification, the split counter electrodes 145a and the split counter electrodes 145b may be referred to as first split counter electrodes and second split counter electrodes, respectively. The first split counter electrodes 145a and the second split counter electrodes 145b are electrically independent, and different counter electrode signals are applied thereto. In the present specification, a signal which is supplied to the first split counter electrodes 145a is referred to as a first counter electrode signal, whereas a signal which is supplied to the second split counter electrodes 145b is referred to as a second counter electrode signal.

A pixel P which is defined by a pixel electrode 124 includes two subpixels SPa and SPb. The subpixel SPa is defined by an overlap between the branches 124v1 and 124v2 and a first split counter electrode 145a, whereas the subpixel SPb is defined by an overlap between the branches 124v3 and 124v4 and a second split counter electrode 145b. Although FIG. 2 shows the length of the split counter electrodes 145a and 145b to be about the same as three pixels in order to prevent the figure from becoming too complicated, it must be noted that the split counter electrodes 145a and 145b extend from one end to the other end of the display region.

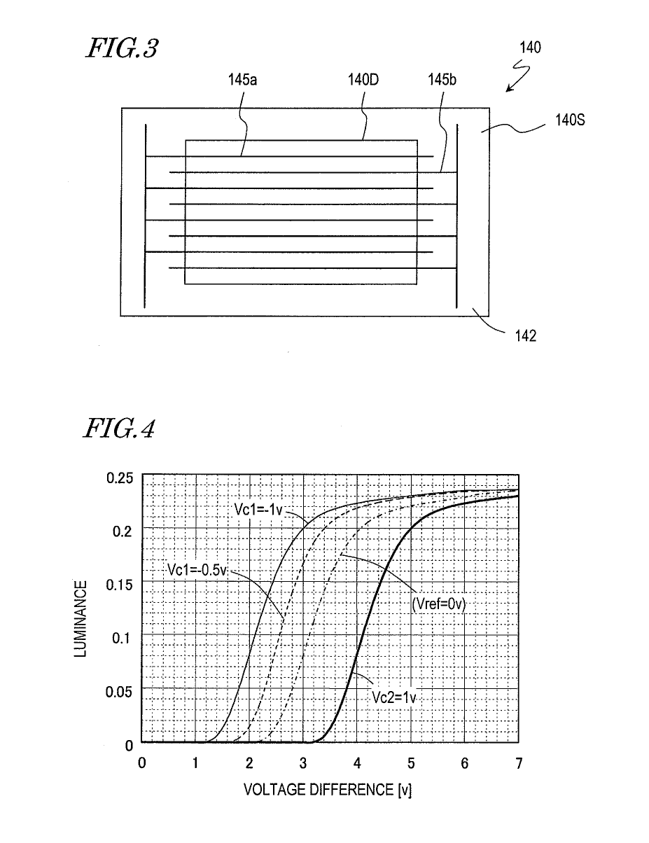

As shown in FIG. 3, the counter substrate 140 includes a display region 140D and a frame region 140S surrounding the display region 140D, and the first counter electrode signal is supplied to the split counter electrodes 145a via wiring lines which are provided in the frame region 140S located to the left of the display region 140D, whereas the second counter electrode signal is supplied to the split counter electrodes 145b via wiring lines which are provided in the frame region 140S located to the right of the display region 140D. Herein, the odd rows of split counter electrodes 145 are electrically connected via wiring lines, and the first counter electrode signal is supplied thereto. The even rows of split counter electrodes 145 are electrically connected via wiring lines, and the second counter electrode signal is supplied thereto. Thus, two comb-shaped electrodes which are separate from one another are provided in the counter electrode 144. The first and second counter electrode signals may be generated in an external circuit and input to the liquid crystal display device 100A via two COM terminals, or the first and second counter electrode signals may be generated in a driver.

FIG. 1 and FIG. 2 are referred to again. When a voltage is applied across the liquid crystal layer 160, the liquid crystal molecules 162 in the liquid crystal layer 160 are aligned in parallel to the direction in which the branches 124v1 to 124v4 extend, whereby liquid crystal domains D1 to D4 are created. In the present specification, the alignment direction of liquid crystal molecules at the center of a liquid crystal domain is referred to as a reference alignment direction, and, within the reference alignment direction, an azimuth angle component that is in a direction from the rear face toward the front face along the major axis of the liquid crystal molecules (i.e., an azimuth angle component of the reference alignment direction as projected onto the principal face of the alignment film 126 or the alignment film 146) is referred to as a reference alignment azimuth. The reference alignment azimuth characterizes its corresponding liquid crystal domain, and predominantly affects the viewing angle characteristics of the liquid crystal domain. Specifically, the reference alignment directions of the liquid crystal domains D1 to D4 are set to be four directions such that the difference between any two directions is substantially equal to an integer multiple of 90°. Specifically, the reference alignment azimuths of the liquid crystal domains D1 to D4 are, respectively, 135°, 45°, 315°, and 225°.

As mentioned earlier, the first counter electrode signal is applied to the first split counter electrodes 145a, and the second counter electrode signal, which is different from the first counter electrode signal, is applied to the second split counter electrodes 145b. Since the potentials of the branches 124v1 to 124v4 within the pixel electrode 124 are equivalent to one another, the voltage which is applied across the liquid crystal layer 160 between the branches 124v1 and 124v2 and any first split counter electrode 145a is different from the voltage which is applied across the liquid crystal layer 160 between the branches 124v3 and 124v4 and any second split counter electrode 145b, so that the transmittance of the subpixel SPa differs from the transmittance of the subpixel SPb in gray scale displaying. Thus, by differentiating the potentials of the split counter electrodes 145a and 145b, two subpixels which can have different luminances are realized even in a construction where one source line, one gate line, one TFT, and one storage capacitor line are provided in connection with one pixel electrode 124; thus, whitening can be efficiently alleviated while suppressing a decrease in the aperture ratio.

In order to prevent the description from becoming too complicated, it is assumed that the gray scale levels of all pixels are equal in the input image signal. For example, when an input image signal which represents all pixels being at the maximum gray scale level is input, the entire screen will display white. When a voltage of 5 V is applied across the liquid crystal layer 160, the pixels will exhibit a transmittance corresponding to the maximum gray scale level.

In the liquid crystal display device 100A of the present embodiment, in order to alleviate whitening, the potential of the counter electrode, rather than the pixel electrodes, is adjusted. Now, the potentials of the pixel electrodes 124, the first split counter electrodes 145a, and the second split counter electrodes 145b relative to a reference potential of the counter electrode will be discussed. For example, when the voltage applied across the liquid crystal layer 160 is 5 V and the potential of the pixel electrodes 124 is higher than the potential of the counter electrode, given that the reference potential of the counter electrode is 0 V, then the potential of the pixel electrodes 124 is 5 V. Note that the reference potential of the counter electrode is not necessarily equal to the so-called ground potential.

For example, the potential of the first split counter electrodes 145a is −1 V relative to the reference potential, and the potential of the second split counter electrodes 145b is +1 V relative to the reference potential. In this case, the voltage applied across the liquid crystal layer 160 in the subpixel SPa is 6 V, and the voltage applied across the liquid crystal layer 160 in the subpixel SPb is 4 V. Thus, the voltage applied across the liquid crystal layer 160 in the subpixel SPa corresponding to any first split counter electrode 145a is different from the voltage applied across the liquid crystal layer 160 in the subpixel SPb corresponding to any second split counter electrode 145b.

Note that the sum of an amount of change in the potential of the first split counter electrodes 145a relative to the reference potential and an amount of change in the potential of the second split counter electrodes 145b relative to the reference potential is substantially zero. Moreover, an average of the transmittances of the subpixel SPa and the subpixel SPb is substantially equal to the pixel transmittance when the reference voltage is applied to the counter electrode.

Now, with reference to FIG. 4, changes in the V-T characteristics in accordance with changes in the potential of the counter electrode will be described. In FIG. 4, the horizontal axis represents a potential difference (or an absolute value thereof) between the potential of the pixel electrodes and the reference potential of the counter electrode; and the vertical axis represents luminance.

When a potential Vc of the counter electrode signal changes by +1 V, the voltage applied across the liquid crystal layer changes by −1 V, and the rise voltage in the V-T curve changes by +1 V. Conversely, when the potential Vc of the counter electrode signal changes by −1 V, the voltage applied across the liquid crystal layer changes by +1 V, and the rise voltage in the V-T curve changes by −1 V.

Similarly, when the potential of the counter electrode signal changes by 0.1 V, the rise voltage of the V-T curve of the pixels changes by 0.1 V. Specifically, when the potential of the pixel electrodes 124 is positive and the potential of the first counter electrode signal is −0.1 V relative to the reference potential of the counter electrode, the rise voltage of the V-T curve of the pixels associated with the first counter electrode signal is −0.1 V relative to the rise voltage of the V-T curve of the pixels associated with the reference potential of the counter electrode. When the potential of the second counter electrode signal is +0.1 V relative to the reference potential of the counter electrode, the rise voltage of the V-T curve of the pixels associated with the second counter electrode signal is +0.1 V relative to the rise voltage of the V-T curve of the pixels associated with the reference potential of the counter electrode. Thus, since regions with different counter electrode potentials are provided, regions with different V-T curves are created, whereby whitening can be alleviated. Moreover, the difference between the applied voltages across the liquid crystal layer corresponds to the difference between the potentials of the counter electrode signals, whereby whitening can be efficiently alleviated.

Thus, the potential of the first split counter electrodes 145a differs from the potential of the second split counter electrodes 145b, but the average between the potential of the first split counter electrodes 145a and the potential of the second split counter electrodes 145b is equal to the reference potential of the counter electrode. Therefore, as will be understood from FIG. 4, the average between the luminance of the subpixel SPa corresponding to the first split counter electrodes 145a, whose potential is shifted by +1 V from the reference potential of the counter electrode, and the luminance of the subpixel SPb corresponding to the second split counter electrodes 145b, whose potential is shifted by −1 V from the reference potential of the counter electrode, is substantially equal to a pixel luminance corresponding to the counter electrode having the reference potential.

In the liquid crystal display device 100A of the present embodiment, the potential of the first split counter electrodes 145a and the potential of the second split counter electrodes 145b are different from each other, and the V-T characteristics of the subpixel SPa differ from the V-T characteristics of the subpixel SPb. In this case, the V-T characteristics of a pixel P are an average of the V-T characteristics of the subpixels SPa and SPb.

Note that the liquid crystal display device 100A may perform line inversion driving. For example, writing is performed in such a manner that, alternately for each pixel row, the potentials of the pixel electrodes 124 and the counter electrode 144 are inverted in terms of which one of them is greater or smaller. Specifically, if the potential of the pixel electrodes 124 is higher than the potential of the counter electrode 144 in a write to the pixels in an n^{th} row, then the potential of the pixel electrodes 124 is lower than the potential of the counter electrode 144 in a write to the pixels in an n+1^{th} row. Thus, line inversion driving may be performed in a pixel-by-pixel manner.

Alternatively, the liquid crystal display device 100A may perform common inversion driving. The potential of the counter electrode 144 varies for each horizontal scanning period, with respect to the ground potential. For example, the potential of the source lines is higher than the reference potential of the counter electrode in a horizontal scanning period for selecting a given row of pixels, and the potential of the source lines is lower than the reference potential of the counter electrode in a horizontal scanning period for selecting a next row of pixels. Thus, the amplitude of the source lines may be equal to or less than the amplitude of the reference potential of the counter electrode. For example, the first counter electrode signal and the second counter electrode signal may each vary so as to have an opposite polarity to that of the potential of the pixel electrodes 124 to which a write is performed, with respect to the ground potential. Through this common inversion driving, it is possible to perform line inversion driving such that the applied voltage across the liquid crystal layer can be increased without increasing the amount of change in the potential of the source line with respect to the ground potential, whereby an increase in power consumption is suppressed.

For example, as shown in FIG. 5, the potentials of the first and second counter electrode signals VC1 and VC2 change for each horizontal scanning period, and the amplitude of the first counter electrode signal VC1 is greater than the amplitude of the second counter electrode signal VC2. As described above, since the amplitude of the source lines is equal to or less than the amplitude of the reference potential of the counter electrode, the transmittance of the subpixel SPa associated with the first counter electrode signal VC1 is higher than that of the subpixel SPb associated with the second counter electrode signal VC2.

For example, when the reference potential of the counter electrode swings 5.4 V with respect to the ground potential, the potential of the first split counter electrodes 145a swings 6.4 V with respect to the ground potential, and the potential of the second split counter electrodes 145b swings 4.4 V with respect to the ground potential. Note that a pull-in voltage is not taken into consideration here. Moreover, a counter adjustment may be made by adjusting the center of the amplitude of each of the first and second counter electrode signals.

Note that when an input image signal which puts all pixels at the maximum gray scale level is input, the potential of the source lines changes with an amplitude of 0.4 V. In this case, the voltage applied across the liquid crystal layer 160 between any first split counter electrode 145a and the branches 124v1 and 124v2 is 6 V, and the voltage applied across the liquid crystal layer 160 between any second split counter electrode 145b and the branches 124v3 and 124v4 is 4 V, so that the transmittance of the subpixel SPa is higher than the transmittance of the subpixel SPb. If a subpixel with a high transmittance are to be called a bright subpixel and a subpixel with a low transmittance are to be called a dark subpixel, the subpixel SPa is the bright subpixel and the subpixel SPb is the dark subpixel herein. Note that, by reducing the amplitudes of the counter electrode signals, power consumption can be reduced, and the liquid crystal display device 100A will be suitably used for mobile devices.

Alternatively, the liquid crystal display device 100A may perform frame inversion driving. In this case, writing is performed in such a manner that, alternately for each frame, the potentials of the pixel electrodes 124 and the counter electrode 144 are inverted in terms of which one of them is greater or smaller. For example, if the potential of the pixel electrodes 124 is higher than the potential of the counter electrode 144 in a write for an N^{th} frame, then the potential of the pixel electrode 124 is lower than the potential of the counter electrode 144 in a write for an N+1^{th} frame.

Alternatively, driving may be performed so that the subpixels in the liquid crystal display device 100A are inverted in terms of bright or dark. In this case, for example, writing is performed in such a manner that, alternately for each frame, the voltage applied across the liquid crystal layer in the subpixel SPa and the voltage applied across the liquid crystal layer in the subpixel SPb are inverted in terms of which one of them is greater or smaller. For example, if the voltage applied across the liquid crystal layer in the subpixel SPa is higher than the voltage applied across the liquid crystal layer in the subpixel SPb in a write for an N^{th} frame, then the voltage applied across the liquid crystal layer in the subpixel SPa is lower than the voltage applied across the liquid crystal layer in the subpixel SPb in a write for an N+1^{th} frame.

In the liquid crystal display device 100A of the present embodiment, in a given vertical scanning period, the subpixel SPa in which the liquid crystal domains D1 and D2 are formed is the bright subpixel, and the subpixel SPb in which the liquid crystal domains D3 and D4 are formed is the dark subpixel. Therefore, based only on the characteristics of this vertical scanning period alone, it may so appear that symmetrical viewing angle characteristics are not attained. However, in the next vertical scanning period, the subpixel SPa in which the liquid crystal domains D1 and D2 are formed becomes the dark subpixel, and the subpixel SPb in which the liquid crystal domains D3 and D4 are formed becomes the bright subpixel. Therefore, over the two consecutive vertical scanning periods, each of the bright subpixel and the dark subpixel spans the liquid crystal domains D1 to D4. Thus, in the liquid crystal display device 100A, for example, the subpixels SPa and SPb are inverted in terms of bright or dark alternately for each vertical scanning period, whereby symmetrical viewing angle characteristics are realized and the viewing angle dependence of the γ characteristics is alleviated. Note that, unless otherwise specified, “one vertical scanning period” means a period which is defined for the liquid crystal display device, rather than a period which is defined by the input image signal. This vertical scanning period corresponds to a period from when a signal voltage is supplied to a given pixel until when a signal voltage is again supplied. For example, 1 frame of an NTSC signal is 33.3 ms, whereas a liquid crystal display device generally writes signal voltages to all pixels in a period of ½ frames of the NTSC signal=1 field (16.7 ms); thus, it is 16.7 ms that defines one vertical scanning period of the liquid crystal display device. Furthermore, in the case where double-speed driving is performed for improving the response characteristics or like purposes, one vertical scanning period of the liquid crystal display device is further halved to 8.3 ms.

Now, the bright-or-dark of the subpixels SPa and SPb will be discussed with respect to the case where the input image signals corresponding to all pixels remain unchanged in their gray scale levels over a plurality of vertical scanning periods defined by the liquid crystal display device 100A, for example. It is meant that this encompasses not only the case where the gray scale level of a given pixel remains equal over a plurality of vertical scanning periods in the input image signal, but also the case where, even if it is one vertical scanning period that the gray scale level of a pixel remains equal in the input image signal, the gray scale level to be displayed by the corresponding pixel of the liquid crystal display device 100A remains unchanged over a plurality of vertical scanning periods due to double-speed driving or the like.

In such cases, in a given vertical scanning period, a write is performed with the first split counter electrodes 145a having a potential of 6.4 V, the second split counter electrodes 145b having a potential of 4.4 V, and the source lines having a potential of 0.4 V, for example. At this time, the voltage applied across the liquid crystal layer 160 between any first split counter electrode 145a and the branches 124v1 and 124v2 is 6 V, and the voltage applied across the liquid crystal layer 160 between any second split counter electrode 145b and the branches 124v3 and 124v4 is 4 V. Therefore, the transmittance of the subpixel SPa is higher than the transmittance of the subpixel SPb, so that the subpixel SPa becomes the bright subpixel and the subpixel SPb becomes the dark subpixel.

In another vertical scanning period (which typically is the next vertical scanning period), a write is performed with the first split counter electrodes 145a having a potential of −4.4 V, the second split counter electrodes 145b having a potential of −6.4 V, and the source lines having a potential of −0.4 V. At this time, the voltage applied across the liquid crystal layer 160 between any first split counter electrode 145a and the branches 124v1 and 124v2 is 4 V, and the voltage applied across the liquid crystal layer 160 between any second split counter electrode 145b and the branches 124v3 and 124v4 is 6 V. Therefore, the transmittance of the subpixel SPa is lower than the transmittance of the subpixel SPb, so that the subpixel SPa becomes the dark subpixel and the subpixel SPb becomes the bright subpixel. Thus, by inverting the pixel polarities and inverting the subpixels in terms of bright or dark for each vertical scanning period, displaying coarseness can be suppressed.

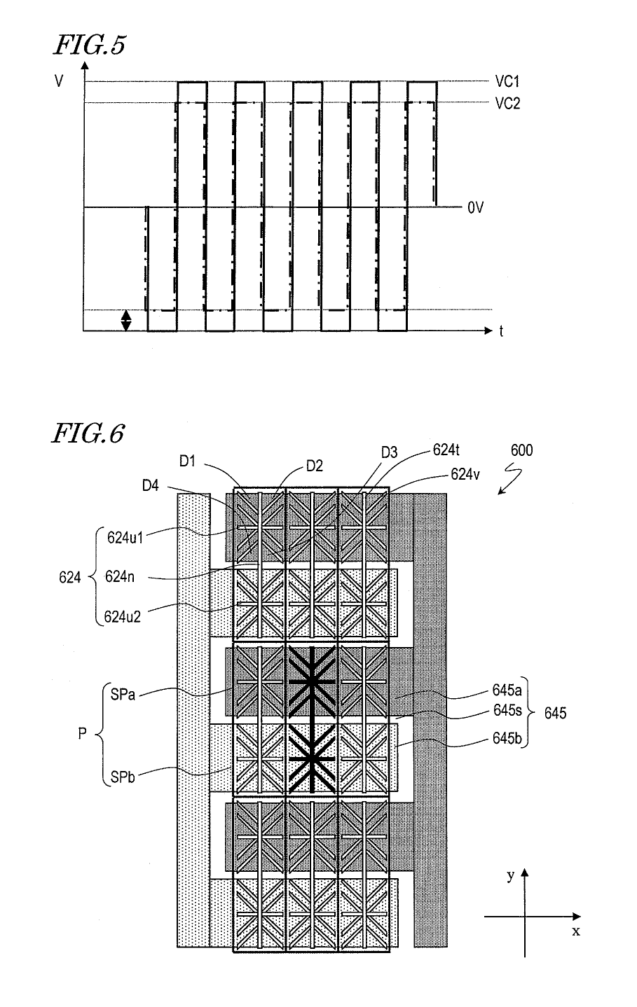

Hereinafter, advantages of the liquid crystal display device of the present embodiment will be described as compared to a liquid crystal display device of Comparative Example. First, with reference to FIG. 6, the construction of a liquid crystal display device 600 of Comparative Example is described. In the liquid crystal display device 600 of Comparative Example, each pixel electrode 624 has unit portions 624u1 and 624u2 and a link portion 624n. The unit portions 624u1 and 624u2 are arranged along the column direction (y direction). The link portion 624n links the unit portion 624u1 to the unit portion 624u2, so that the potential of the unit portion 624u1 is equal to the potential of the unit portion 624u2. The unit portion 624u1 has a cross-shaped stem 624t and branches 624v extending from the stem 624t, and the unit portion 624u2 has a similar shape to that of the unit portion 624u1.

In the liquid crystal display device 600, too, split counter electrodes 645 extend linearly along the row direction. A linear slit 645s is provided between adjoining split counter electrodes 645. The slits 645s are provided between two adjoining rows of pixel electrodes 624 as well as between the unit portions 624u1 and the unit portions 624u2 of the pixel electrodes 624 in each row. Therefore, the number of split counter electrodes 645 is twice the number of rows of pixel electrodes 624, and the width of the split counter electrodes 645 is a half of that along the column direction (length along the y direction) of the pixel electrodes 624.

In the liquid crystal display device 600, any first split counter electrode 645a overlapping the unit portion 624u1 of a pixel electrode 624 is electrically independent from the second split counter electrode 645b overlapping the unit portion 624u2 of that pixel electrode 624, and different counter electrode signals are applied to them. Any pixel P defined by a pixel electrode 624 includes two subpixels SPa and SPb. The subpixel SPa is defined by an overlap between the unit portion 624u1 and a first split counter electrode 645a, whereas the subpixel SPb is defined by an overlap between the unit portion 624u2 and a second split counter electrode 645b. Thus, in the liquid crystal display device 600, any split counter electrode 645 is provided so as to overlap a corresponding row of subpixels.

In the liquid crystal display device 600 as such, liquid crystal domains D1 to D4 are formed in each of the subpixels SPa and SPb. In the split counter electrodes 645 of the liquid crystal display device 600, linear slits 645s are provided between the unit portions 624u1 and 624u2 as well as between pixel electrodes 624 adjoining along the column direction. Therefore, near the slits 645s, adequate voltage application across the liquid crystal layer is not achieved, and transmittance is deteriorated. Moreover, when pixels of a relatively small size are to be realized, not only is there a relatively large number of slits 645s, but also the fact that each of the unit portions 624u1 and 624u2 included in the pixel electrodes 624 has a fishbone structure makes the width of the slits 645s short. This makes it easier for any adjoining first and second split counter electrodes 645a and 645b to conduct, and thus leak failures are likely to occur.

On the other hand, in the liquid crystal display device 100A of the present embodiment, the number of slits 145s is small relative to the number of rows of pixels, and therefore deterioration in transmittance can be suppressed. Moreover, when pixels of a relatively small size are to be realized, not only is there a small number of slits 145s, but also the fact that pixel electrodes 124 having a single fishbone structure may be formed makes it easy to ensure a broad width of the slits 145s. Thus, occurrence of leak failures can be suppressed, and deterioration in production yield can be suppressed.

In the liquid crystal display device 600 of Comparative Example, four liquid crystal domains are created in each of the bright subpixel and the dark subpixel in any arbitrary vertical scanning period, thus alleviating the viewing angle dependence of the y characteristics and realizing symmetrical viewing angle characteristics. On the other hand, in the liquid crystal display device 100A of the present embodiment, only two liquid crystal domains are created in the subpixel SPa and the subpixel SPb, when any given vertical scanning period is considered alone. Theoretically speaking, therefore, if the gray scale level of the input image signal varies greatly from vertical scanning period to vertical scanning period, adequate symmetrical viewing angle characteristics may not be realized. However, in actual images, the gray scale level of the input image signal does not change very much, and therefore the liquid crystal display device 100A of the present embodiment realizes symmetrical viewing angle characteristics and alleviates the viewing angle dependence of the y characteristics by inverting the subpixels SPa and SPb in terms of bright or dark for each vertical scanning period, as described above. Moreover, the bright subpixel and the dark subpixel are created within one pixel P in the liquid crystal display device 100A, so that deterioration in display quality is not likely to be recognized.

It is illustrated above that the fishbone structure of each pixel electrode 124 is an axisymmetrical shape with respect to a line which is parallel to the row direction passing through the center thereof, such that a first split counter electrode 145a is disposed on one side of the axis and a second split counter electrode 145b is disposed on the other side of the axis, the area of the subpixel SPa being equal to the area of the subpixel SPb; however, the present invention is not limited thereto. The area of the subpixel SPa may be different from the area of the subpixel SPb.

However, it is preferable that the area of the subpixel SPa is equal to the area of the subpixel SPb. For example, if the subpixel SPa is greater in area than the subpixel SPb, the average luminance of the entire pixel P over a plurality of consecutive vertical scanning periods will correspond to the gray scale level of the input image signal, but the average luminance of the entire pixel P in each vertical scanning period will not correspond to the gray scale level of the input image signal. Moreover, for example, the areas of the liquid crystal domains D1 to D4 of the bright subpixel will not be constant over a plurality of vertical scanning periods, so that symmetrical viewing angle characteristics cannot be realized. On the other hand, when the subpixels SPa and SPb are equal in area, it is ensured that the luminance of the entire pixel P corresponds to the gray scale level of the input image signal in each vertical scanning period, and symmetrical viewing angle characteristics can be realized.

Note that it is preferable to apply a Polymer Sustained Alignment Technology (hereinafter referred to as the “PSA technology”) to the liquid crystal display device 100A. In the PSA technology, the pretilt direction of liquid crystal molecules is controlled by a polymerization product which is generated by irradiating a polymerizable compound with an active energy ray (e.g., ultraviolet light) while applying a voltage across a liquid crystal layer in which a small amount of polymerizable compound (e.g., a photopolymerizable monomer) is mixed. Use of the PSA technology makes for an improved response speed. Japanese Laid-Open Patent Publication No. 2002-357830 and Japanese Laid-Open Patent Publication No. 2003-149647, which disclose the PSA technology, are incorporated herein by reference.

By applying the PSA technology, apart from the alignment films 126 and 146, alignment sustaining layers (not shown) are provided between the alignment films 126 and 146 and the liquid crystal layer 160 in the liquid crystal display device 100A. Owing to the alignment sustaining layers, the liquid crystal molecules 162 are maintained in a state which is slightly inclined from the normal directions of the principal faces of the alignment films 126 and 146, whereby the response speed of the liquid crystal is improved. This tilt is 2°, for example.

When the first and second split counter electrodes 145a and 145b have different potentials, if the applied voltages in adjoining liquid crystal regions are different, the liquid crystal molecules may become unstable in alignment under the influence of the voltage difference. In particular, the liquid crystal molecules 162 receive an alignment regulating force to become parallel to the equipotential lines, so that some of the liquid crystal molecules 162 which are in regions of the higher applied voltage within the liquid crystal layer 160 are aligned so as to be oriented toward the region of the lower applied voltage. As a result, within the liquid crystal layer 160, the liquid crystal molecules 162 in the region of the higher applied voltage will be more disordered than the liquid crystal molecules 162 in the region of the lower applied voltage. On the other hand, by applying the PSA technology to provide alignment sustaining layers, the alignment of the liquid crystal molecules 162 (in particular, the liquid crystal molecules 162 in the central portion of the pixel electrode 124) is stabilized even when the potentials of the counter electrodes are different, and disorder in alignment is suppressed.

The liquid crystal display device 100A is produced as follows. First, on an insulative substrate 122, gate lines, storage capacitor lines, and source lines not shown are formed. Thereafter, an electrically conductive material is deposited and patterned, thereby forming pixel electrodes 124. The fishbone structure of the pixel electrodes 124 is formed through the patterning. Thereafter, an alignment film 126 is formed on the pixel electrodes 124. In this manner, an active matrix substrate 120 is formed.

Next, a color filter layer not shown is formed on an insulative substrate 142. Thereafter, an electrically conductive material is deposited and patterned, thereby forming a counter electrode 144. Split counter electrodes 145 of the counter electrode 144 are formed through the patterning. Thereafter, an alignment film 146 is formed on the counter electrode 144. In this manner, a counter substrate 140 is formed. Next, a liquid crystal layer 160 is formed between the active matrix substrate 120 and the counter substrate 140.

When the PSA technology is applied, a polymerizable compound is mixed into the liquid crystal material composing the liquid crystal layer 160. While applying a voltage between the pixel electrodes 124 and the counter electrode 144, light is radiated to polymerize the polymerizable compound in the liquid crystal layer 160. Specifically, while incessantly applying a voltage of 10 V to the gate lines, a voltage of predetermined rectangular waves is applied to the source lines. The potential of the rectangular waves applied to the source lines is what would correspond to usual white displaying, but may vary depending on the pretilt of the liquid crystal molecules 162. Strictly speaking, a pretilt of the liquid crystal molecules 162 will differ depending on the lamp illuminance, wavelength, and duration during polymerization, the alignment film material (which typically is polyimide), the liquid crystal material, and so on. For example, while incessantly applying a DC voltage of 10 V to the gate lines, a voltage of AC 10 V is applied to the source lines at a frequency of 60 Hz. By performing polymerization in this manner, alignment sustaining layers are formed between the active matrix substrate 120 and the liquid crystal layer 160, and between the counter substrate 140 and the liquid crystal layer 160. The alignment sustaining layers allow the alignment of the liquid crystal molecules 162 to be stabilized even when adjoining split counter electrodes 145 have different potentials.

It is illustrated above that one of the first and second counter electrode signals is greater in amplitude than the other in a given vertical scanning period; however, the present invention is not limited thereto. The amplitude of the first counter electrode signal may be equal to the amplitude of the second counter electrode signal, and the absolute value of the voltage of the first counter electrode signal and the absolute value of the voltage of the second counter electrode signal may be inverted in terms of which one of them is greater or smaller for every horizontal scanning period.

In the above description with reference to FIG. 5, the first split counter electrodes 145a and the second split counter electrodes 145b are provided from one side of the frame region 140S with respect to the display region 140D, and make their ways across the display region 140D; however, the present invention is not limited thereto. Each of the first split counter electrodes 145a and the second split counter electrodes 145b may be provided so as to extend from both sides of the frame region 140S with respect to the display region 140D.

It is illustrated above that a pixel P has one each of liquid crystal domains D1 to D4 in the liquid crystal display device 100A; however, the present invention is not limited thereto. A pixel P may have the liquid crystal domains D1 to D4 in plurality.

It is illustrated above that the pixel electrodes 124 have a fishbone structure in the liquid crystal display device 100A; however, the present invention is not limited thereto. The liquid crystal display device 100A may be of the CPA mode. Alternatively, the four liquid crystal domains of each pixel of the liquid crystal display device 100A may be realized by the alignment films 126 and 146, which define the pretilt of the liquid crystal molecules 162. The alignment film 126 may have two regions in which the liquid crystal molecules are inclined in mutually antiparallel directions with respect to the normal direction of the principal face, and similarly, the alignment film 146 may have two regions in which the liquid crystal molecules are inclined in mutually antiparallel directions with respect to the normal direction of the principal face. The direction of tilt of the liquid crystal molecules 162 near the principal face of the alignment film 126 has a difference which is an integer multiple of about 90° from the direction of tilt of the liquid crystal molecules 162 near the principal face of the alignment film 146, whereby, under an applied voltage, liquid crystal domains having reference alignment azimuths in four directions are created in one pixel, such that the difference between any two arbitrary directions is substantially equal to an integer multiple of 90°. As such alignment films 126 and 146, so-called optical alignment films can be suitably used.

Alternatively, the liquid crystal display device 100A may be of the MVA mode. In the case where first and second alignment regulating means are provided on the liquid crystal layer 160 sides, respectively, of the active matrix substrate 120 and the counter substrate 140, liquid crystal domains in which liquid crystal molecules 162 are aligned in azimuths that are 180° apart are created on both sides of each of the first and second alignment regulating means. As the alignment regulating means, various alignment regulating means (domain regulating means) as disclosed in Japanese Laid-Open Patent Publication No. 11-242225 can be used. As the first alignment regulating means, slits (i.e., portions where no conductive film exists) may be provided in the pixel electrodes 124, or ribs may be provided on the pixel electrodes 124 as the first alignment regulating means. As the second alignment regulating means, ribs (protrusions) may be provided on the split counter electrodes 145, or slits may be provided in the split counter electrodes 145 as the second alignment regulating means.

It is illustrated above that each pixel has regions exhibiting two different kinds of V-T characteristics; however, the present invention is not limited thereto. Each pixel may have regions exhibiting three or more different kinds of V-T characteristics.

In the above description, each split counter electrode overlaps a plurality of pixel electrodes; however, the present invention is not limited thereto.

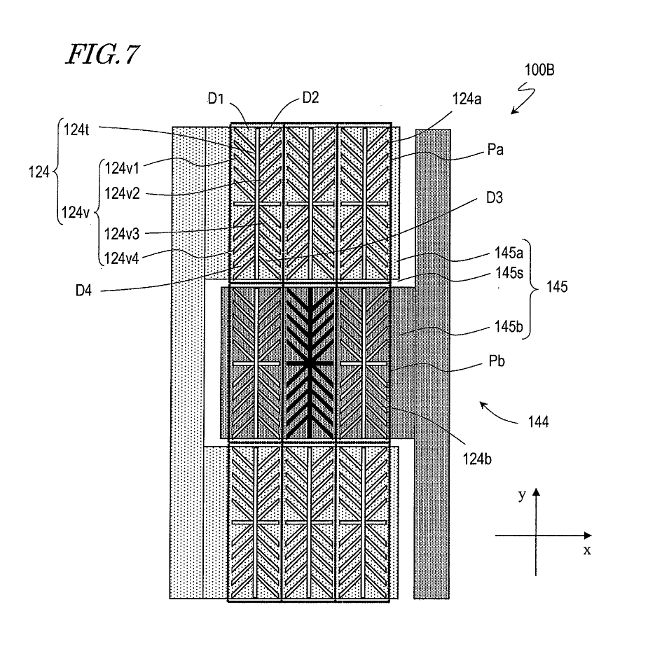

Hereinafter, a second embodiment of the liquid crystal display device according to the present invention will be described with reference to FIG. 7. The liquid crystal display device 100B of the present embodiment has a construction similar to that of the liquid crystal display device of Embodiment 1 described above except for the different positioning of the pixel electrodes and split counter electrodes, and any overlapping description will be omitted in order to avoid redundancy.

In the liquid crystal display device 100B, too, a pixel electrode 124 has a cross-shaped stem 124t and branches 124v extending from the stem 124t. The branches 124v1 and 124v3 extend in an azimuth angle direction of 135° and an azimuth angle direction of 315°, whereas the branches 124v2 and 124v4 extend in an azimuth angle direction of 45° and an azimuth angle direction of 225°. Thus, the pixel electrode 124 has a fishbone structure. Each pixel electrode 124 is sized 135 μm×45 μm. The width of the stem 124t, the width of the branches 124v, and the pitch of the branches 124v are 4 μm, 2.5 μm, and 5.0 μm, respectively.

In the liquid crystal display device 100B of the present embodiment, the counter electrode 144 has a plurality of split counter electrodes 145 which are separate from one another. In the liquid crystal display device 100B, the split counter electrodes 145 extend linearly in the row direction. Linear slits 145s are provided between adjoining split counter electrodes 145, such that each split counter electrode 145 overlaps the entirety of the pixel electrodes 124 in the corresponding row. The split counter electrodes 145 have a width (length along the y direction) of 135 μm, and the slits 145s have a width of 5 μm. The slits 145s are provided so as to correspond to the interval between two adjoining rows of pixel electrodes 124. The number of split counter electrodes 145 is substantially equal to the number of rows of pixel electrode 124, and the split counter electrodes 145 have a width which is substantially equal to the length along the column direction (y direction) of the pixel electrodes 124.

In the liquid crystal display device 100B, the split counter electrodes 145 are separated so as to correspond to pixel electrodes 124 arranged along the row direction. Among the split counter electrode 145, those which overlap a pixel electrode 124a are designated split counter electrodes 145a, for example, and those which overlap a pixel electrode 124b are designated split counter electrodes 145b. In the present specification, the split counter electrodes 145a and the split counter electrodes 145b may be referred to as first split counter electrodes and second split counter electrodes, respectively. The first split counter electrodes 145a are electrically independent from the second split counter electrodes 145b, and different counter electrode signals are applied thereto.

In the liquid crystal display device 100B of the present embodiment, too, the number of slits 145s is small relative to the number of rows of pixels, and therefore deterioration in transmittance can be suppressed. Moreover, when pixels of a relatively small size are to be realized, not only is there a small number of slits 145s, but also the fact that pixel electrodes 124 having a single fishbone structure may be formed makes it easy to ensure a broad width of the slits 145s. Thus, occurrence of leak failures can be suppressed, and deterioration in production yield can be suppressed.

In order to prevent the description from becoming too complicated, it is assumed herein that the gray scale levels of all pixels are equal in the input image signal. In the liquid crystal display device 100B, for example, in a given vertical scanning period, a given pixel exhibits a luminance which is higher than the luminance corresponding to a gray scale level that is indicated by the input image signal. Then, in a next vertical scanning period, the same pixel exhibits a luminance which is lower than the luminance corresponding to a gray scale level that is indicated by the input image signal. An average of the luminances in the two vertical scanning periods is equal to the luminance corresponding to the gray scale level indicated by the input image signal.

For example, two pixels Pa and Pb adjoining along the column direction will be discussed with respect to the case where the input image signals corresponding to all pixels remain unchanged in their gray scale levels over a plurality of vertical scanning periods defined by the liquid crystal display device 100B. In a given vertical scanning period, a write to the pixel Pa is performed with the first split counter electrode 145a having a potential of 6.4 V and the source line having a potential of 0.4 V, and then, a write to the pixel Pb is performed with the second split counter electrode 145b having a potential of −4.4 V and the source line having a potential of −0.4 V, for example. In this case, the pixel Pa is higher in luminance than the pixel Pb, such that the pixel Pa exhibits a luminance corresponding to the bright subpixel and the pixel Pb exhibits a luminance corresponding to the dark subpixel.

In another vertical scanning period (which typically is the next vertical scanning period), a write to the pixel Pa is performed with the first split counter electrode 145a having a potential of −4.4 V and the source line having a potential of −0.4 V, and then, a write to the pixel Pb is performed with the second split counter electrode 145b having a potential of +6.4 V and the source line having a potential of +0.4 V, for example. In this case, the pixel Pb is higher in luminance than the pixel Pa, such that the pixel Pa exhibits a luminance corresponding to the dark subpixel and the pixel Pb exhibits a luminance corresponding to the bright subpixel. In this manner, the liquid crystal display device 100B alleviates the viewing angle dependence of the γ characteristics. Moreover, in the liquid crystal display device 100B, by inverting the pixel polarities and inverting the pixels in terms of bright or dark for each frame, displaying coarseness is suppressed.

Moreover, in the liquid crystal display device 100B, even if the potentials of the first split counter electrodes 145a and the second split counter electrodes 145b are constant over one vertical scanning period, it is possible to increase the voltage applied across the liquid crystal layer 160 without increasing the amount of change in the potential of the source lines. However, even in this case, it is preferable to invert the polarity of the voltage applied across the liquid crystal layer 160 in another vertical scanning period (which typically is the next vertical scanning period), in order to prevent the liquid crystal layer 160 from deteriorating.

As described earlier, in the liquid crystal display device 600 of Comparative Example, four liquid crystal domains are created in each of the bright subpixel and the dark subpixel in any arbitrary vertical scanning period. On the other hand, in the liquid crystal display device 100B of the present embodiment, liquid crystal domains D1 to D4 corresponding to the bright subpixel are created in a given vertical scanning period, and liquid crystal domains D1 to D4 corresponding to the dark subpixel are created in a next vertical scanning period.

In the liquid crystal display device 100A, one pixel has the bright subpixel and the dark subpixel. On the other hand, in the liquid crystal display device 100B, one pixel has a luminance corresponding to the bright subpixel or the dark subpixel when any given vertical scanning period is considered alone, so that a decrease in resolution may be perceived in the liquid crystal display device 100B. Therefore, it is preferable that the liquid crystal display device 100B is driven with a short vertical scanning period.

It is illustrated above that a pixel P has one each of liquid crystal domains D1 to D4 in the liquid crystal display device 100B; however, the present invention is not limited thereto. A pixel P may have the liquid crystal domains D1 to D4 in plurality.

It is illustrated above that the pixel electrodes 124 have a fishbone structure in the liquid crystal display device 100B; however, the present invention is not limited thereto. The liquid crystal display device 100B may be of the CPA mode. Alternatively, the four liquid crystal domains of each pixel of the liquid crystal display device 100B may be realized by the alignment films 126 and 146, which define the pretilt of the liquid crystal molecules 162. Alternatively, the liquid crystal display device 100B may be of the MVA mode or any other mode.

The PSA technology is also applicable to the liquid crystal display device 100B, which will make for an improved response speed and also stabilize the alignment of the liquid crystal molecules 162. This will attain large effects especially in the case where slits are provided as at least one of the first alignment regulating means and the second alignment regulating means.

It is illustrated above that the pixels exhibit two different kinds of V-T characteristics depending on the vertical scanning period; however, the present invention is not limited thereto. The pixels may exhibit three or more V-T characteristics depending on the vertical scanning period.

It is illustrated above that a plurality of split counter electrodes are electrically connected to one another in the frame region; however, the present invention is not limited thereto. A plurality of counter electrode signals may be supplied from a driver (not shown) to the respective ones of the plurality of split counter electrodes.

It is illustrated above that two different counter electrode signals are applied to the plurality of split counter electrodes; however, the present invention is not limited thereto. Three or more different counter electrode signals may be applied to the plurality of split counter electrodes.

According to the present invention, a liquid crystal display device which suppresses a decrease in the aperture ratio of a display region and which efficiently alleviates whitening can be provided. Such a liquid crystal display device is suitably used in digital cameras, mobile phones, game devices, and the like.

### REFERENCE SIGNS LIST

100A, 100B liquid crystal display device

120 active matrix substrate

124 pixel electrode

126 alignment film

140 counter substrate

144 counter electrode

145 split counter electrode

146 alignment film

1. A liquid crystal display device comprising:
a plurality of pixel electrodes arranged in a matrix array of a plurality of rows and a plurality of columns;
a counter electrode; and
a liquid crystal layer interposed between the plurality of pixel electrodes and the counter electrode, wherein,
the counter electrode includes a plurality of split counter electrodes; and
each of the plurality of split counter electrodes overlaps a portion of a pixel electrode in each of two adjoining rows.

2. A liquid crystal display device comprising:
a plurality of pixel electrodes arranged in a matrix array of a plurality of rows and a plurality of columns;
a counter electrode; and
a liquid crystal layer interposed between the plurality of pixel electrodes and the counter electrode, wherein,
the counter electrode includes a plurality of split counter electrodes; and
each of the plurality of split counter electrodes overlaps an entire pixel electrode in each corresponding row.

3. The liquid crystal display device according to claim 1, wherein, when a gray scale level of an input image signal corresponding to a given pixel remains unchanged over a plurality of vertical scanning periods of the liquid crystal display device, a region corresponding to one of two adjoining split counter electrodes corresponding to the given pixel has a luminance higher than a luminance of a region corresponding to the other split counter electrode in a given vertical scanning period, but the region corresponding to the one split counter electrode has a luminance lower than a luminance of the region corresponding to the other split counter electrode in another vertical scanning period.

4. The liquid crystal display device according to claim 3, wherein, when a gray scale level of an input image signal corresponding to a given pixel remains unchanged over a plurality of vertical scanning periods of the liquid crystal display device, an average of luminances of regions corresponding to two split counter electrodes that correspond to the given pixel over a plurality of consecutive vertical scanning periods corresponds to the gray scale level of the input image signal.

5. The liquid crystal display device according to claim 3, wherein, when a gray scale level of an input image signal corresponding to a given pixel remains unchanged over a plurality of vertical scanning periods of the liquid crystal display device, an average between a luminance of the region corresponding to the one split counter electrode and a luminance of the region corresponding to the other split counter electrode corresponds to the gray scale level of the input image signal in any arbitrary vertical scanning period.

6. The liquid crystal display device according to claim 2, wherein, when a gray scale level of an input image signal corresponding to a given pixel remains unchanged over a plurality of vertical scanning periods of the liquid crystal display device, a luminance of a region corresponding to a split counter electrode corresponding to the given pixel in a given vertical scanning period is different from a luminance of the region corresponding to the split counter electrode corresponding to the given pixel in another vertical scanning period.

7. The liquid crystal display device according to claim 6, wherein, when a gray scale level of an input image signal corresponding to a given pixel remains unchanged over a plurality of vertical scanning periods of the liquid crystal display device, an average of the luminance of the region corresponding to the split counter electrode corresponding to the given pixel taken over a plurality of consecutive vertical scanning periods corresponds to the gray scale level of the input image signal.

8. The liquid crystal display device of according to claim 1, wherein, when gray scale levels of input image signals corresponding to all pixels remain unchanged over a plurality of vertical scanning periods of the liquid crystal display device, a region corresponding to one of two adjoining split counter electrodes has a luminance higher than a luminance of a region corresponding to the other split counter electrode in a given vertical scanning period, but the region corresponding to the one split counter electrode has a luminance lower than a luminance of the region corresponding to the other split counter electrode in another vertical scanning period.

9. The liquid crystal display device of according to claim 1, wherein each of the plurality of split counter electrodes has a shape extending along a row direction.

10. The liquid crystal display device according to claim 1, wherein, under an applied voltage, liquid crystal molecules in the liquid crystal layer are aligned in first, second, third, and fourth reference alignment azimuths differing from one another by an integer multiple of essentially 90 degrees.

11. The liquid crystal display device according to claim 1, wherein a width of each of the plurality of split counter electrodes is essentially equal to a length of each of the plurality of pixel electrodes along a column direction.
